(19) United States
(12) Patent Application Publication
(10) Pub. No.: US 2004/0221739 A1
(43) Pub. Date: Nov. 11, 2004

(54) Bread maker

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/806,212

(22) Filed: Mar. 23, 2004

(30) Foreign Application Priority Data
May 7, 2003 (KR) 2003-29125

(51) Int. Cl. A23L 1/00

(52) U.S. Cl. 99/348

(57) ABSTRACT

A bread maker including a main body having an oven compartment; an oven including a rear part and a side part accommodated in the oven compartment; a spacing part provided between the main body and the oven to form a space between the main body and the oven; and an insulation member interposed in the space between the main body and the oven. Accordingly, this configuration provides a bread maker in which an insulation member is interposed between a main body and an oven, thereby preventing not only loss of heat and loss of electricity, but also accidents caused due to a current leakage. Further, an aspect of the present invention provides a bread maker, in which a main body and an oven are securely combined, thereby decreasing unnecessary movement of the bread maker and enhancing durability thereof.

### CROSS-REFERENCE TO RELATED APPLICATIONS

This application claims the benefit of Korean Patent Application No. 2003-29125, filed May 7, 2003, in the Korean Intellectual Property Office, the disclosure of which is incorporated herein by reference.

### BACKGROUND OF THE INVENTION

1. Field of the Invention

The present invention relates to a bread maker, and more particularly, to a bread maker having an improved combination structure of a main body and an oven.

2. Description of the Related Art

The conventional bread maker developed thus far allows a user to easily and conveniently make the bread by automatically performing a series of baking processes.

A conventional bread maker typically comprises: a main body having an oven compartment, an oven accommodated in the oven compartment of the main body, a heater to heat the inside of the oven, and a door provided in the front of the main body to allow opening and closing of the oven compartment.

However, design of the conventional bread maker's combination structure of the main body and the oven has focused solely on combining the main body with the oven, and the design has not considered the fact that the combination structure can affect humidity, temperature, heat transmission, etc. during a baking process.

Therefore, while using the conventional bread maker, it is difficult to maintain a stable baking condition, and durability of the bread maker decreases in cases where problems arise in the combination structure of the main body and the oven.

Further, while using the conventional bread maker, there is no insulation provided between the main body and the oven. Therefore, loss of heat, loss of electricity, and accidents caused due to a current leakage are likely to occur.

### SUMMARY OF THE INVENTION

Accordingly, it is an aspect of the present invention to provide a bread maker in which the main body and the oven are securely combined, and loss of heat and loss of electricity are effectively prevented.

Additional aspects and advantages of the invention will be set forth in part in the description which follows and, in part, will be obvious form the description, or may be learned by practice of the invention.

The foregoing and/or other aspects of the present invention are achieved by providing a bread maker comprising: a main body having an oven compartment; an oven including a rear part and a side part accommodated in the oven compartment; a spacing part provided between the main body and the oven to form a space between the main body and the oven; and an insulation member interposed in the space between the main body and the oven.

According to an aspect of the invention, the spacing part protrudes towards the rear part of the oven to form the space in which the insulation member is interposed, and includes at least one first protruding part formed with a first screw hole; and at least one first screw passing through the main body and inserted into the first screw hole of the first protruding part.

According to yet another aspect of the invention, the spacing part protrudes towards the side part of the oven to form the space in which the insulation member is interposed, and includes at least one second protruding part formed with a second screw hole; and at least one second screw passing through the main body and inserted into the second screw hole of the second protruding part.

According to an aspect of the invention, the spacing part protrudes towards the rear part of the oven to form the space in which the insulation member is interposed, and includes at least one first bracket formed with a first screw hole; and at least one first screw passing through the main body and inserted into the first screw hole of the first bracket.

According to an aspect of the invention, the spacing part protrudes towards the side part of the oven to form the space in which the insulation member is interposed, and includes at least one second bracket formed with a second screw hole; and at least one second screw passing through the main body and inserted into the second screw hole of the second bracket.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a perspective view of a bread maker according to an aspect of the present invention;

FIG. 2 is a perspective view of the bread maker with a door open;

FIG. 3 is an exploded perspective view of a main body and an oven of a bread maker;

FIG. 4 is a combined perspective view of the main body and the oven of FIG. 3;

FIGS. 5A and 5B are partial sectional views to illustrate a combination structure of the main body and the oven of the bread maker according to one embodiment of the present invention; and

FIGS. 6A and 6B are partial sectional views to illustrate a combination structure of the main body and the oven of the bread maker according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

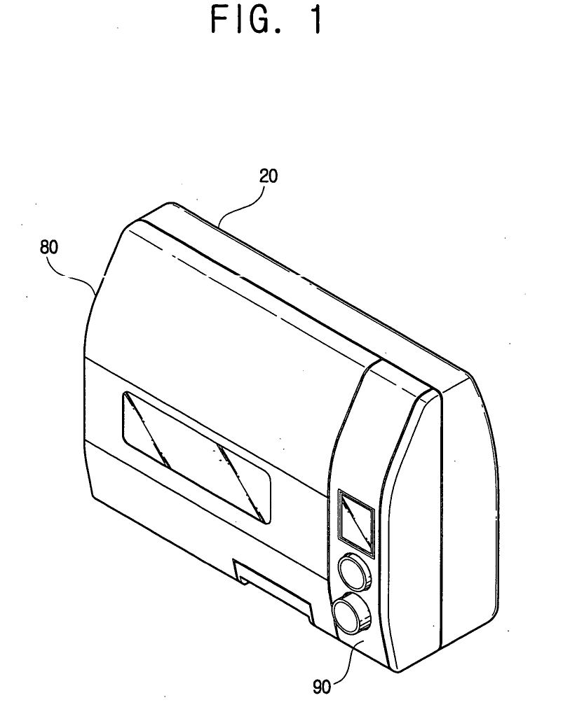

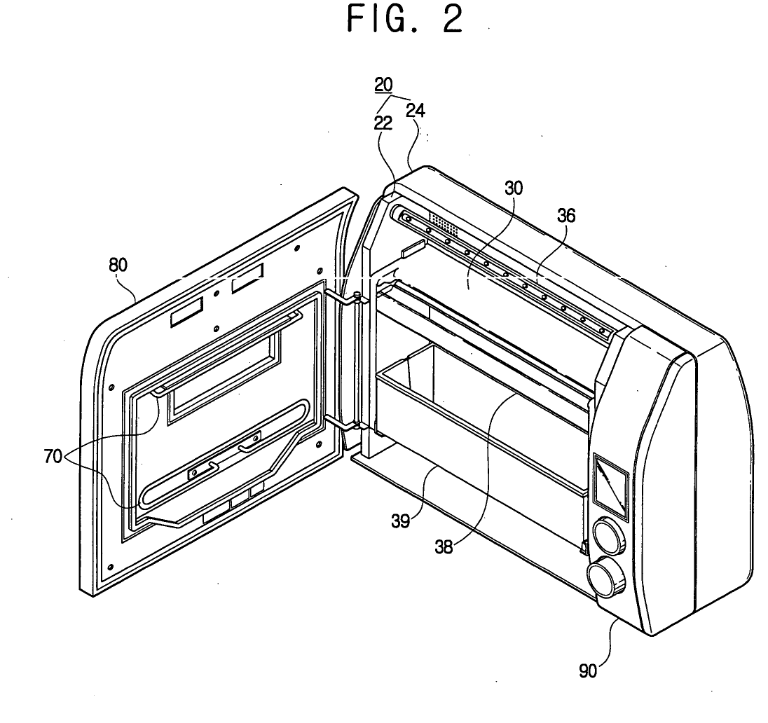

As shown in FIGS. 1 and 2, a bread maker according to an aspect of the present invention comprises: a main body 20, an oven 30 accommodated in the main body 20, a plurality of heaters 70 to heat the inside of the oven 30, and a door 80 provided in the front of the main body 20 to open and close the oven 30.

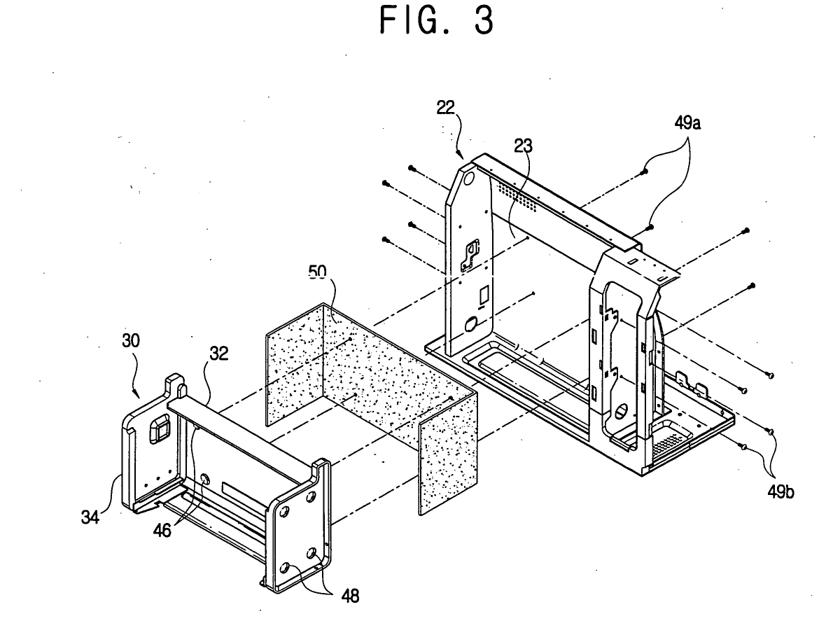

The main body 20 includes: a frame 22 forming an oven compartment 23, as shown in FIG. 3, in which the oven 30 is accommodated; a frame cover 24, as shown in FIG. 2, to cover the outside of the frame 22, and a control panel 90, as shown in FIG. 1, provided in a front side of the main body 20 to allow a user to control the bread maker and to view an operating state of the bread maker.

In upper and lower sides of the oven 30 are provided an upper kneading drum (not shown) and a lower kneading drum (not shown), which are disposed parallel to each other and alternate clockwise and counterclockwise rotations. On the upper kneading drum 36 and the lower kneading drum are wound opposite ends of a mixing bag (not shown) filled with the ingredients for the bread, respectively. Between the upper kneading drum 36 and the lower kneading drum is provided a pair of dough-blocking members 38 to prevent dough from being kneaded in the mixing bag from moving towards the upper kneading drum 36. Further, inside the oven 30 is provided a baking tray 39 shaped like a box with a top opening to contain the completely kneaded dough. The baking tray 39 is preferably made of aluminum, steel, or other material that has good heat-resisting property.

The door 80 is rotatably combined to the main body 20 to selectively open and close a front opening of the oven 30.

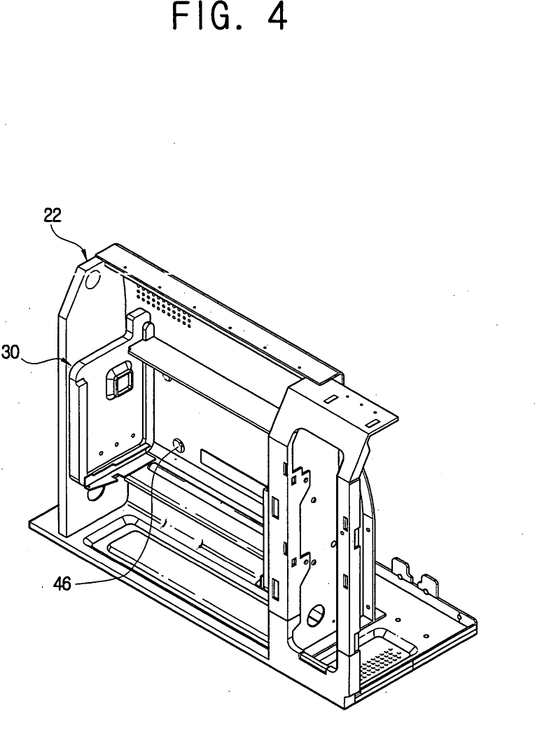

In FIGS. 3, 4, 5A and 5B, a spacing part 40 is provided between the frame 22 and the oven 30 used to combine the frame 22 with the oven 30 and to form a predetermined space to interpose an insulation member 50 therebetween.

The frame 22 forms the oven compartment 23 in which the oven 30 is accommodated, and the oven 30 comprises a rear part 32 and a side part 34.

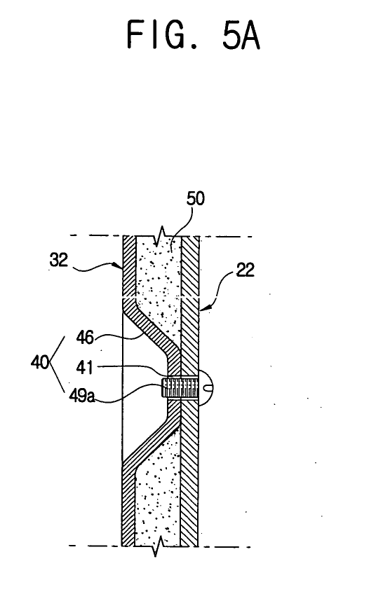

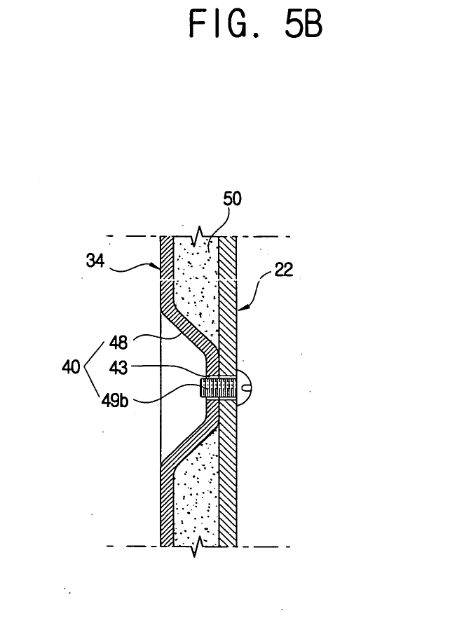

As shown in FIG. 5A, on the rear part 32 of the oven 30, the spacing part 40 protrudes towards the frame 22 to form a space in which the insulation member 50 is placed, where the spacing part 40 includes at least one first protruding part 46 formed with a first screw hole 41, and at least one first screw 49a passing through the frame 22 and inserted into the first screw hole 41 of the first protruding part 46.

To more securely combine the frame 22 with the oven 30, as shown in FIG. 5B, preferably, on the side part 34 of the oven 30, the spacing part 40 protrudes towards the frame 22 to form a space in which the insulation member 50 is placed, wherein the spacing part 40 includes at least one second protruding part 48 formed with a second screw hole 43, and at least one second screw 49b passing through the frame 22 and inserted into the second screw hole 43 of the second protruding part 48.

The first and second protruding parts 46 and 48 can have a variety of structures as necessary. Further, the first and second screws 49a and 49b to be combined to the first and second protruding parts 46 and 48 can be substituted with various combining devices.

The insulation member 50 is made of mica, glass fiber, etc., and is employed to prevent passage of heat and electricity.

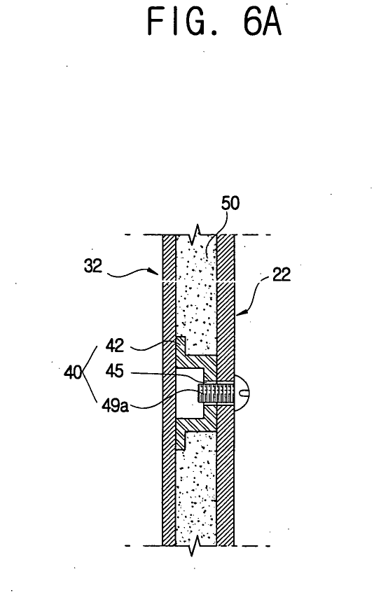

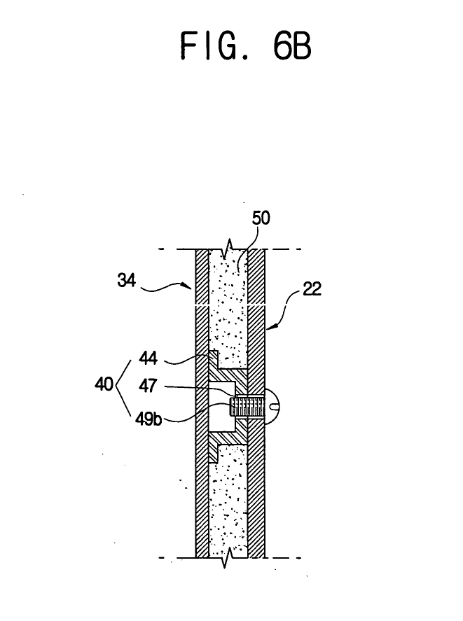

FIGS. 6A and 6B are partial sectional views to illustrate a combination structure of the main body and the oven in the bread maker according to another embodiment of the present invention. In this embodiment, brackets are used instead of the above-described protruding parts shown in FIGS. 3, 4, 5A and 5B.

As shown in FIG. 6A, on the rear part 32 of the oven 30, the spacing part 40 protrudes towards the frame 22 to form a space in which the insulation member 50 is inserted, wherein the spacing part 40 includes at least one first bracket 42 formed with a first screw hole 45, and at least one first screw 49a passing through the frame 22 and inserted into the first screw hole 45 of the first bracket 42.

To more securely combine the frame 22 with the oven 30, as shown in FIG. 6B, preferably, on the side part 34 of the oven 30, the spacing part 40 protrudes towards the frame 22 to form a space in which the insulation member 50 is inserted, wherein the spacing part 40 includes at least one second bracket 44 formed with a second screw hole 47, and at least one second screw 49b passing through the frame 22 and inserted into the second screw hole 47 of the second bracket 44.

As described above, the present invention provides a bread maker in which an insulation member is interposed between a main body and an oven, thereby preventing not only loss in heat and loss of electricity but also accidents caused due to a leakage current.

Further, the present invention provides a bread maker in which a main body and an oven are securely combined, thereby decreasing unnecessary moment of the bread maker to enhance the durability thereof.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bread maker, comprising:
a main body having an oven compartment;
an oven including a rear part and a side part accommodated in the oven compartment of the main body;
a spacing part provided between the main body and the oven to form a space between the main body and the oven; and
an insulation member interposed in the space between the main body and the oven.

2. The bread maker according to claim 1, wherein
the spacing part protrudes towards the rear part of the oven to form the space in which the insulation member is interposed;
at least one first protruding part formed with a first screw hole; and
at least one first screw passing through the main body and inserted into the first screw hole of the respective first protruding part.

3. The bread maker according to claim 1, wherein
the spacing part protrudes towards the side part of the oven to form the space in which the insulation member is interposed,
at least one second protruding part formed with a second screw hole; and
at least one second screw passing through the main body and inserted into the second screw hole of the respective second protruding part.

4. The bread maker according to claim 2, wherein
the spacing part protrudes towards the side part of the oven to form the space in which the insulation member is interposed;
at least one second protruding part formed with a second screw hole; and
at least one second screw passing through the main body and inserted into the second screw hole of the respective second protruding part.

5. The bread maker according to claim 1, wherein
the spacing part protrudes towards the rear part of the oven to form the space in which the insulation member is interposed;
at least one first bracket formed with a first screw hole; and
at least one first screw passing through the main body and inserted into the first screw hole of the respective first bracket.

6. The bread maker according to claim 1, wherein
the spacing part protrudes towards the side part of the oven to form the space in which the insulation member is interposed,
at least one second bracket formed with a second screw hole; and
at least one second screw passing through the main body and inserted into the second screw hole of the respective second bracket.

7. The bread maker according to claim 5, wherein
the spacing part protrudes towards the side part of the oven to form the space in which the insulation member is interposed;
at least one second bracket formed with a second screw hole; and
at least one second screw passing through the main body and inserted into the second screw hole of the respective second bracket.

8. The bread maker according to claim 1, further comprising:
a frame forming an oven compartment of the main body;
a frame cover to cover the outside of the frame; and
a control panel to allow a user to control the bread maker and to view an operating state of the bread maker.

9. The bread maker according to claim 8, wherein a side of the spacing part is adjacent to the frame of the oven to form the space in which the insulation member is interposed.

10. The bread maker, comprising:
an oven including a rear part and a side part; an oven compartment;
a frame forming the oven compartment; and
a spacing part provided between the frame and the oven to combine the frame with the oven, and to form a predetermined space to interpose an insulation.

11. The bread maker according to claim 1, wherein the spacing part protrudes towards the frame to form a space in which the insulation member is placed.

12. The bread maker according to claim 11, the spacing part further comprising:
at least one first protruding part formed with a first screw hole; and
at least one first screw passing through the main body and inserted into the first screw hole of the respective first protruding part.

13. The bread maker according to claim 8, wherein on the side part of the oven, the spacing part protrudes towards the frame to form a space in which the insulation member is placed.

14. The bread maker according to claim 13, the spacing part further comprising:
at least one second protruding part formed with a second screw hole; and
at least one second screw passing through the main body and inserted into the second screw hole of the respective second protruding part.

15. A bread maker according to claim 1, wherein the spacing part includes at least one first bracket formed with a first screw hole.

16. The bread maker according to claim 10, wherein
the spacing protrudes towards the rear part of the oven to form the space in which the insulation member is interposed;
at least one first bracket formed with a first screw hole; and
at least one first screw passing through the main body and inserted into the first screw hole of the respective first protruding part.

17. The bread maker according to claim 16, wherein
the spacing protrudes towards the side part of the oven to form the space in which the insulation member is interposed,
at least one second bracket formed with a second screw hole; and
at least one second screw passing through the main body and inserted into the second screw hole of the respective second protruding part.

18. The bread maker according to claim 11, the spacing part further comprising:
at least one first bracket formed with a first screw hole; and
at least one first screw passing through the main body and inserted into the first screw hole of the respective second protruding part.

19. The bread maker according to claim 18, the spacing part further comprising:
at least one second bracket formed with a second screw hole; and
at least one second screw passing through the main body and inserted into the second screw hole of the respective second protruding part.

20. A bread maker including an oven compartment, comprising:
a frame to form the oven compartment; and
an oven including a rear part and a side part accommodated in the oven compartment, and separated by a space from the frame; and
an insulation provided between the frame and the oven which combines the frame with the oven.
